(19) United States
(12) Patent Application Publication
(10) Pub. No.: US 2003/0223475 A1
(43) Pub. Date: Dec. 4, 2003

(54) Fast acquisition spread spectrum data communication protocol

(76) Inventor: Daniel M. Hatton, Folleh, TX (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/397,888

(22) Filed: Mar. 26, 2003

Related U.S. Application Data
(60) Provisional application No. 60/367,800, filed on Mar. 27, 2002.

(51) Int. Cl. H04B 1/69

(52) U.S. Cl. 375/130

(57) ABSTRACT

The present disclosure provides a protocol for frequency hopping spread spectrum transmission of a message in which the hop sequence is dynamically determined based on the usage frequency of each of the hop frequencies to a receiver that is not required to transmit an acknowledgement having the steps of A. selecting a data frequency by selecting the least frequently used available data frequency; B. transmitting a meet message on at least one of a predetermined number of meet message frequencies, the meet message comprising the identity of a data frequency upon which a data message will be sent; C. transmitting a data message upon the data frequency for no longer than a maximum period of time; D. upon expiration of the maximum period of time, determining whether more data is to be sent to the receiver; and E. if more data is to be sent, transmitting a next data frequency upon which data will be sent and transmitting the additional data upon the next data frequency.

### REFERENCE TO RELATED APPLICATIONS

The present application claims priorty to U.S. Provisional Patent Application Serial No. 60/367,800 filed Mar. 27, 2002, the contents of which are hereby incorporated by reference.

### BACKGROUND OF THE INVENTION

Spread spectrum radio transmission is known in the art. Generally, two transceivers syncronize transmission and follow a list of frequencies upon which they will each transmit and receive signals from one another. Currently, the Federal Communications Commission requires spread spectrum transceivers to use at least fifty frequencies in the transmission of messages, no frequency may be used for greater than four hundred milliseconds in a twenty second period, and all frequencies must be used equally.

However, for devices that transmit and/or receive small and infrequent messages, current spead spectrum transmission protocols are insufficient. Additionally, for systems where the receiver, due to power limitations, does not also transmit, current protocols are insufficient. Generally, these protocols take a long time for the receiver to find the transmitter and require the receiver to always be powered. Additionally, current protocols require the receiver to transmit a response in order to synchronize or remain synchronized with the transmitter.

### SUMMARY OF THE INVENTION

The present invention provides a protocol for spread spectrum transmission of a message to a receiver that does not transmit an acknowledgement comprising the steps of:

A. transmitting a meet message on at least one of a predetermined number of meet message frequencies, the meet message comprising the identity of a data frequency upon which a data message will be sent;

B. transmitting a data message upon the data frequency for no longer than a maximum period of time;

C. upon expiration of the maximum period of time, determining whether more data is to be sent to the receiver; and

D. if more data is to be sent, transmitting a next data frequency upon which data will be sent and transmitting the additional data upon the next data frequency.

### DESCRIPTION OF THE DRAWINGS

FIG. 1 is a flow chart of the spread spectrum data communication protocol of the present invention;

FIG. 2 is a flow chart of the meet frequency selection subroutine of the present invention;

FIG. 3 is a flow chart of the begin transmission subroutine of the present invention;

FIG. 4 is a flow chart of the transmit message function of the present invention; and

FIG. 5 is a flow chart of the receive message function of the present invention.

### DETAILED DESCRIPTION OF THE PREFERRED EMBODIMENT

The preferred embodiment of the present invention provides a transmitter that can transmit a message via spread spectrum radio transmission to a receiver that may not have the capability to transmit an acknowledgement of any kind. Additionally, the present protocol allows transmission to a receiver that is not always on. For example, a preferred receiver turns on about once per second for only about 30 to 50 milliseconds, although different intervals and durations may be used without departing from the scope of the present invention. In this manner, a receiver that receives only short and infrequent messages may conserve power resources, such as a receiver that operates on solar and/or battery power.

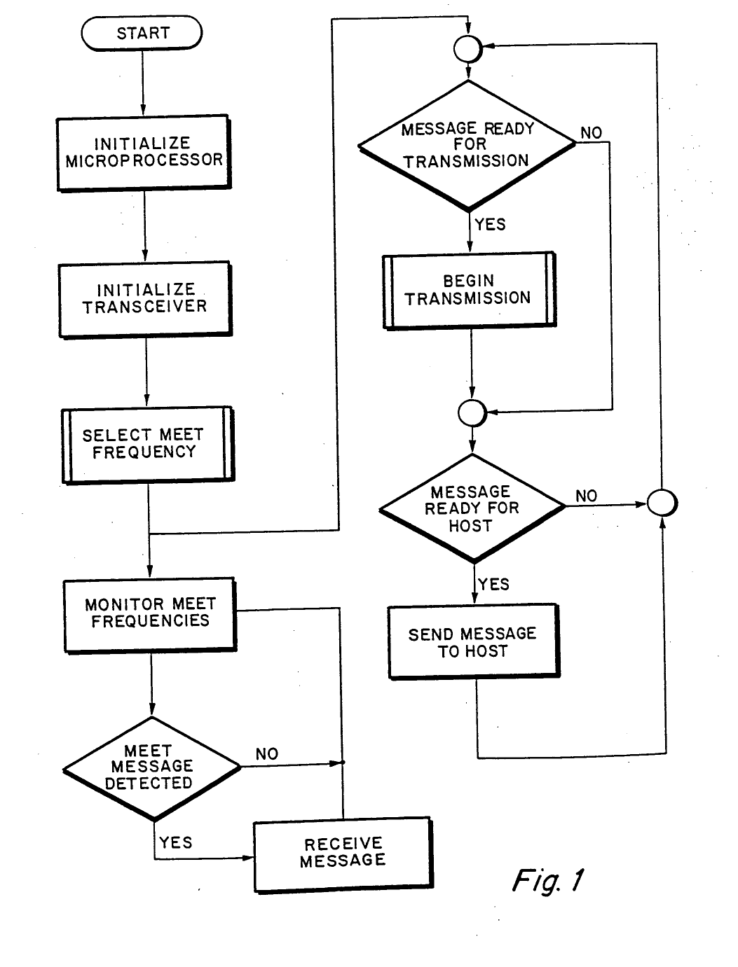

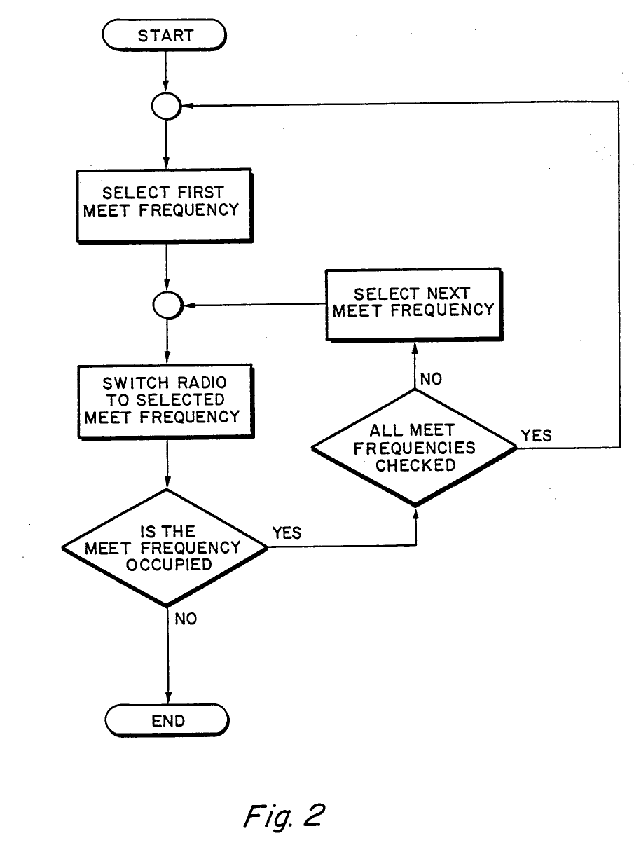

Referring to FIG. 1, there is shown an operational diagram of a fast acquisition spread spectrum data communication radio. In first steps, the radio initializes a microprocessor and transceiver for sending and receiving messages. Next, the radio selects a meet frequency. Referring to FIG. 2, the meet frequency is selected by selecting a frequency from a stored list of meet frequencies. Next, the radio switches its receiver to the meet frequency to determine whether there is a third party transmission or interference on that frequency. If the frequency is not occupied the radio uses the frequency as the meet frequency. If the frequency is occupied, the radio determines if it has exhausted its list of stored meet frequencies. If it has exhausted its list of stored meet frequencies, then the radio returns to the first meet frequency and proceeds through the list again. If the radio has not exhausted its list of stored meet frequencies, the radio selects the next meet frequency on the stored list and monitors its receiver on that frequency in order to determine whether there is a third party transmission or interference on that frequency.

Referring back to FIG. 1, the radio next determines whether there is a message ready for transmission. Simultaneously, the radio begins to monitor the selected meet frequency and if a meet message on a meet frequency is detected it will interrupt the steps of FIG. 1 to receive the message.

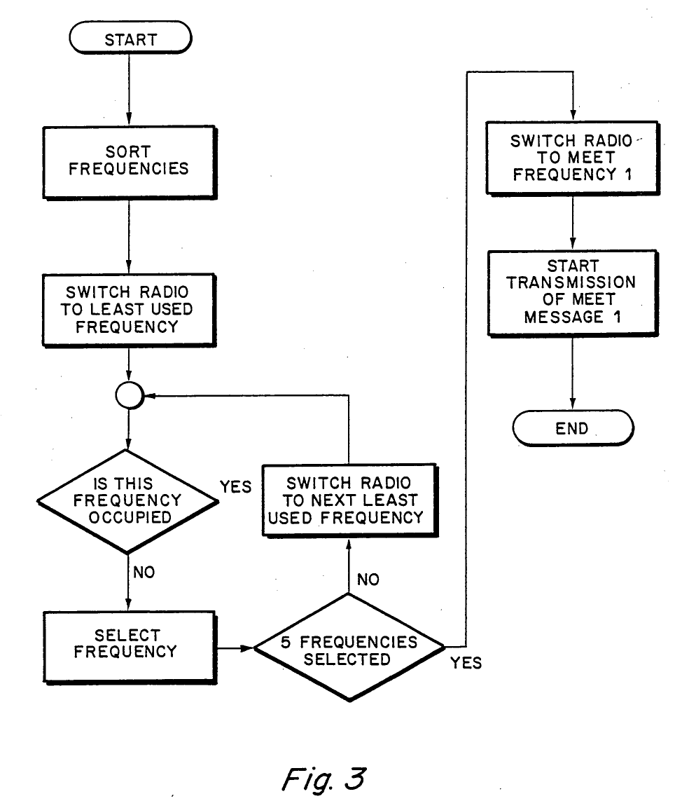

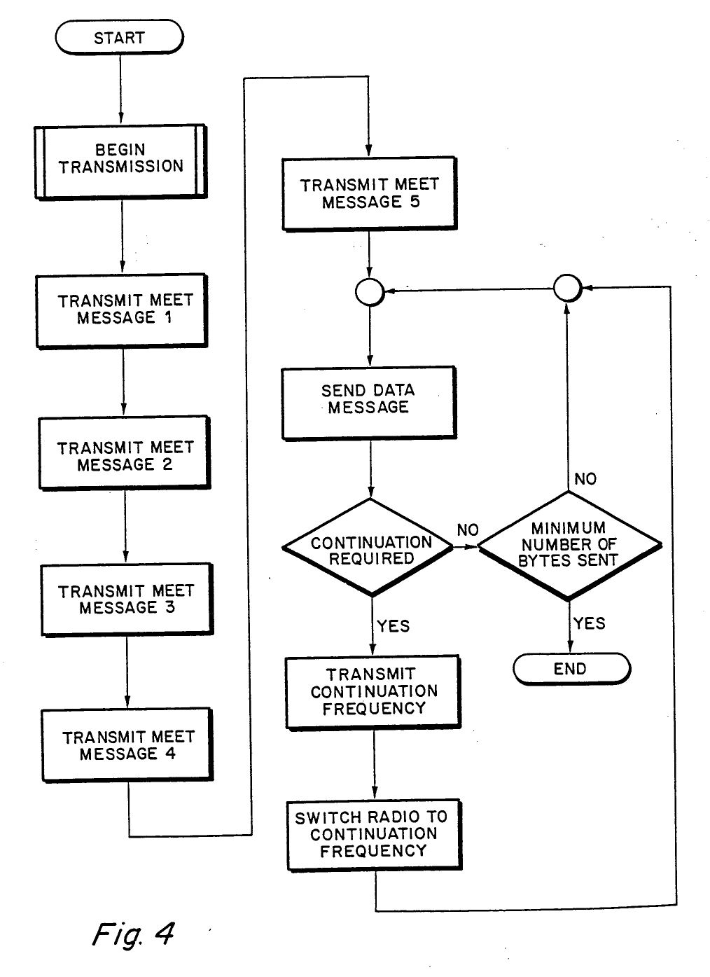

If a message is ready for transmission, transmission of the message is begun. Referring to FIG. 3, a transmission is begun by sorting the frequencies available to the radio on which to transmit by order of the amount of previous transmission activity that has occurred on each frequency by the radio. The frequency that has been previously used least is selected from the sorted list. The radio then determines whether there is a third party transmission or interference on that frequency. If the frequency is not available, then the next-least used frequency is selected from the list and that frequency is monitored for a third party transmission or interference on that frequency. If the frequency is not occupied, the radio determines if five available frequencies have been determined. If not, the process is repeated until five unused frequencies have been determined. If so, the radio is switched to the first meet frequency and a meet message is begun. Referring to FIG. 4, a meet message is transmitted on each of the five meet frequencies so that the receiver will receive a meet message regardless of which meet frequency it selected. The meet message comprises the frequency at which the data message will be transmitted.

Next, the data message is transmitted at the frequency transmitted to the receiver in the meet message. When the maximum number of bytes has been transmitted, the radio determines whether there are more bytes to be transmitted. If so, the radio transmits the next frequency on which it will transmit the continuing data and then switches to that frequency to transmit the next maximum number of bytes. This continues until the message has been sent, and the radio continues to monitor the amount of activity it has transmitted upon each frequency in order to later determine its least used frequencies. If the radio runs out of data to transmit before the maximum amount of data has been sent on a frequency, the radio determines if the minimum amount of data has been sent for the message. If the minimum has been sent, the routine ends. If the minimum has not been sent, the short message is repeated until the minimum amount of data has been sent. Minimums are required to guaranty that the meet frequencies are not used more than the other frequencies.

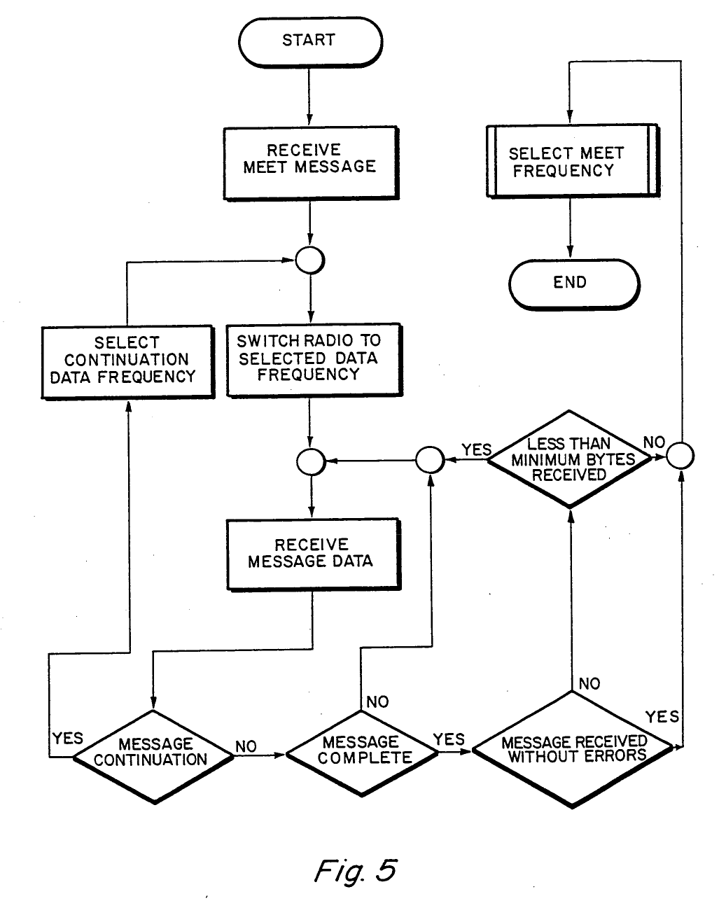

Referring to FIGS. 1 and 5, in order to receive the message, the receiver listens on the selected meet frequencies for the meet message. When the meet message has been received, the radio switches to the frequency it has received in the meet message to receive the transmitted data message and receives the message. Next, the receiver reads the message and determines whether the message will be continued on a subsequent frequency. If so, the receiver switches to the continuation frequency and receives the continuation message. If not, the receiver checks to see if the message is complete. If the message is not complete, the receiver continues to listen for the message. If the message is complete, the receiver determines if the message contains any errors. If the message contains errors and less than the minimum number of bytes were received, the receiver continues to listen for the message on the selected frequency. If the message is received without errors, the receiver marks the message as ready to be sent to the host system. Whether or not the message was received without errors, the receiver again selects a meet frequency as previously described and returns to FIG. 1.

I claim:

1. A protocol for spread spectrum radio transmission comprising the steps of:
A. transmitting a meet message on at least one of a predetermined number of meet message frequencies, the meet message comprising the identity of a data frequency upon which a data message will be sent;
B. transmitting a data message upon the data frequency for no longer than a maximum period of time;
C. upon expiration of the maximum period of time, determining whether more data is to be sent to the receiver; and
D. if more data is to be sent, transmitting a next data frequency upon which data will be sent and transmitting the additional data upon the next data frequency.

2. The protocol of claim 1 wherein the step of transmitting a meet message on at least one of a predetermined number of meet message frequencies comprises the step of transmitting a meet message on all of the predetermined number of meet message frequencies.

3. The protocol of claim 1 wherein the data frequency transmitted in step A comprises one of a predetermined number of data frequencies and further comprises the steps of:
tracking the usage of each of the predetermined number of data frequencies;
selecting the next data frequency to be used in step D, by selecting the least used frequency of the predetermined number of data frequencies.

4. The protocol of claim 3 wherein the step of selecting the next data frequency to be used further comprises the steps of:
selecting the next data frequency to be used in step D, by:
1. selecting the least used frequency of the predetermined number of data frequencies;
2. determining whether there is interference present on the least used frequency;
3. selecting the least used frequency, if interference is not present upon the frequency;
4. re-performing steps 1-3 until a predetermined number of data frequencies are selected upon which there is no interference.

5. The protocol of claim 1 further comprising the step of transmitting the meet message a plurality of times before transmitting the data message.

6. The protocol of claim 1 further comprising the step of transmitting the meet message upon a plurality of different meet frequencies before transmitting the data message.

7. A protocol for spread spectrum radio transmission comprising the steps of:
A. transmitting a meet message on at least one of a predetermined number of meet message frequencies, the meet message comprising the identity of a data frequency upon which a data message will be sent;
B. transmitting a data message upon the data frequency for no longer than a maximum period of time;
C. upon expiration of the maximum period of time, determining whether more data is to be sent to the receiver;
D. if more data is to be sent, transmitting a next data frequency upon which data will be sent and transmitting the additional data upon the next data frequency;
E. if more data is not to be sent, determining whether a minimum number of bytes have been sent; and
F. if a minimum number of bytes have not been sent, the transmission is repeated until a minimum number of bytes have been sent.

8. The protocol of claim 7 wherein the step of transmitting a meet message on at least one of a predetermined number of meet message frequencies comprises the step of transmitting a meet message on all of the predetermined number of meet message frequencies.

9. The protocol of claim 7 wherein the data frequency transmitted in step A comprises one of a predetermined number of data frequencies and further comprises the steps of:
tracking the usage of each of the predetermined number of data frequencies;
selecting the next data frequency to be used in step D, by selecting the least used frequency of the predetermined number of data frequencies.

10. The protocol of claim 9 wherein the step of selecting the next data frequency to be used further comprises the steps of:
selecting the next data frequency to be used in step D, by:
1. selecting the least used frequency of the predetermined number of data frequencies;
2. determining whether there is interference present on the least used frequency;
3. selecting the least used frequency, if interference is not present upon the frequency;
4. re-performing steps 1-3 until a predetermined number of data frequencies are determined upon which there is no interference.

11. The protocol of claim 7 further comprising the step of transmitting the meet message a plurality of times before transmitting the data message.

12. The protocol of claim 7 further comprising the step of transmitting the meet message upon a plurality of different meet frequencies before transmitting the data message.

13. A protocol for spread spectrum radio transmission comprising the steps of:
providing a transmitter that performs the steps of:
A. transmitting a meet message on at least one of a predetermined number of meet message frequencies, the meet message comprising the identity of a data frequency upon which a data message will be sent;
B. transmitting a data message upon the data frequency for no longer than a maximum period of time;
C. upon expiration of the maximum period of time, determining whether more data is to be sent to the receiver; and
D. if more data is to be sent, transmitting a next data frequency upon which data will be sent and transmitting the additional data upon the next data frequency; and
providing a receiver that performs the steps of:
A. monitoring one or more meet message frequencies for the presence of a meet message;
B. receiving a meet message from the transmitter upon one or more of the monitored meet message frequencies;
C. switching the receiver to monitor a data message frequency specified in the meet message;
D. receiving the data message on the data message frequency;
E. determining whether the data message indicates a next data frequency for a message continuation; and
F. if the data message indicates a next data frequency, switching the receiver to monitor the next data message frequency specified in the data message.

14. The protocol of claim 13 wherein the receiver monitors a plurality of meet message frequencies.

15. The protocol of claim 13 wherein the transmitter performs the steps of:
E. if more data is not to be sent, determining whether a minimum number of bytes have been sent;
F. if a minimum number of bytes have not been sent, repeating the transmission until a minimum number of bytes have been sent.

16. The protocol of claim 13 wherein the receiver performs the steps of:
a. selecting the first of a predetermined number of meet message frequencies;
b. determining whether there is interference present on the meet message frequency;
c. if no interference is detected on the meet message frequency, selecting the meet message frequency for monitoring for transmission of a meet message; and
d. if interference is detected on the meet message frequency, selecting the next of the predetermined number of meet message frequencies and re-performing steps b through d.

17. The protocol of claim 16 wherein when all of the predetermined number of meet message frequencies have been found to have interference present, the first of the predetermined number of meet message frequencies is reselected and the steps of claim 16 re-performed.

18. The protocol of claim 13 wherein the data frequency transmitted in step A comprises one of a predetermined number of data frequencies and further comprises the steps of:
tracking the usage of each of the predetermined number of data frequencies;
selecting the next data frequency to be used in step D, by selecting the least used frequency of the predetermined number of data frequencies

19. The protocol of claim 18 wherein step of selecting the next data frequency to be used further comprises the steps of:
selecting the next data frequency to be used in step D, by:
1. selecting the least used frequency of the predetermined number of data frequencies;
2. determining whether there is interference present on the least used frequency;
3. selecting the least used frequency, if interference is not present upon the frequency;
4. re-performing steps 1-3 until a predetermined number data frequencies are determined upon which there is no interference.

20. The protocol of claim 13 further comprising the step of transmitting the meet message a plurality of times before transmitting the data message.

21. The protocol of claim 13 further comprising the step of transmitting the meet message upon a plurality of different meet message frequencies before transmitting the data message.
